(19) United States
(12) Patent Application Publication
(10) Pub. No.: US 2003/0135759 A1
(43) Pub. Date: Jul. 17, 2003

(54) Method for representing, storing and editing network security policy

(76) Inventors: Sook Yeon Kim, Daejeon (KR); Geon Lyang Kim, Jeollanam-do (KR); Myung Eun Kim, Daejeon (KR); Ki Young Kim, Daejeon (KR); Jong Soo Jang, Daejeon (KR); Sung Won Sohn, Daejeon (KR); Hyochan Bang, Daejeon (KR)

Correspondence Address: JACOBSON HOLMAN PLLC, 400 SEVENTH STREET N.W., SUITE 600, WASHINGTON, DC, 20004, US

(21) Appl. No.: 10/234,207

(22) Filed: Sep. 5, 2002

(30) Foreign Application Priority Data
Jan. 16, 2002 (KR) 2002-02465

(51) Int. Cl. H04L 9/00; H04L 9/32

(52) U.S. Cl. 713/201

(57) ABSTRACT

A network security policy is represented, stored and edited by using a rule object, a condition object, an action object, and their associations. The condition object is a one-packet-condition object, a repeated-packet-condition object or a linear-packet-condition object. The action object is an alert-action object, a packet-drop-action object, a packet-admission-action object, a session-drop-action object, a session-admission-action object, a session-logging-action object, a traceback-action object or an ICMP-unreachable-message-sending-action object.

### FIELD OF THE INVENTION

The present invention relates to a method for representing, storing and editing a network security policy; and, more particularly, to a method for representing, storing and editing a network security policy including a rule object for representing a security rule itself, a condition object for representing a condition which the rule is applied based on, and an action object for representing an action to be performed when the condition is satisfied.

### BACKGROUND OF THE INVENTION

As the Internet plays a more critical role in a plurality of industries, its service area has been more widely broaden and the number of its users is more explosively increasing. However, structural weakness of transmission control protocol/Internet protocol (TCP/IP) results in an exposure of its security defects and thus an exponential increase of security accidents.

Thus, a great effort has been made to develop a network level security system such as an intrusion detection system (IDS), a firewall, a virtual private network (VPN) system and an anti-virus system.

However, those systems currently available may not be compatible with each other because each system has its own operation structure and management mechanism. Such incompatibility gives heavy burdens to operators who have to manage a network including a plurality of security systems.

Meanwhile, a policy-based network management (PBNM) has been developed as a solution to effectively manage various network devices including security systems. The PBNM provides a consistent, unified and easily controllable network management. This benefit of PBNM appreciates more highly as the network becomes more complex and offers more services.

The standardization of the PBNM has been accomplished in the Internet engineering task force (IETF). Resource allocation protocol (RAP) working group in the IETF defines policy provisioning objects for the common open policy (COPS) and the COPS policy provisioning (COPS-PR). Further, the policy framework working group in the IETF suggests a policy core information model (PCIM), which is a framework for representing, managing, storing and editing a policy.

The PCIM of the policy framework working group was standardized as RFC3060. In addition, an updated version thereof is now being prepared. Since the PCIM includes only abstract concepts to be applied to all application fields, it requires additional concepts for a practical use in a specific application field. Therefore, additional concepts specifically necessary for Quality of Service (QoS) and IP SECurity protocol (IPSEC) have been established based on the PCIM.

However, there is needed a method for applying the PCIM to a network security field for an effective management of a network security policy.

### SUMMARY OF THE INVENTION

It is, therefore, an object of the present invention to provide a method for effectively representing, storing and editing a network security policy by defining and using rule objects, condition objects, action objects and their associations.

In accordance with a preferred embodiment of the present invention, there is provided a method for storing a network security policy, comprising a step of: storing the network security policy by using a rule object including properties of a rule itself, a condition object for representing a condition which the rule is applied based on, an action object for representing an action to be performed when the condition is satisfied, an association between the rule object and the condition object and an association between the rule object and the action object, wherein the condition object is a one-packet-condition object for representing a condition for analyzing one packet, a repeated-packet-condition object for representing a case in which packets are repeatedly received, each of the packets having the same pattern, or a linear-packet-condition object for representing a case in which a series of packets having a predetermined pattern are successively received; or the condition object is an object being associated with one of the one-packet-condition object, the repeated-packet-condition object and the linear-packet-condition object, wherein the repeated-packet-condition object has one or more properties for representing an interval of time and the number of repeated packets; and the repeated-packet-condition object is associated with at least one one-packet-condition object for representing a condition for analyzing each of the repeated packets, and wherein the linear-packet-condition object has a property for representing the number of the series of packets; and the linear-packet-condition object is associated with at least one one-packet-condition object for representing a condition for analyzing each of the series of packets.

In accordance with another preferred embodiment of the present invention, there is a method for storing a network security policy, comprising a step of: storing the network security policy by using a rule object including properties of a rule itself, an action object for representing a security action and an association between the rule object and the action object, wherein the action object is an alert-action object for representing an action of alerting a user to a rule application situation, a packet-drop-action object for representing an action of blocking a packet currently examined, a packet-admission-action object for representing an action of admitting the packet, a session-drop-action object for representing an action of blocking a session having the packet, a session-admission-action object for representing an action of admitting a session having the packet, a session-logging-action object for representing an action of storing information on a session having the packet, a traceback-action object for representing an action of tracing back to a source location of the packet, or an ICMP-unreachable-message-sending-action object for representing an action of sending an ICMP-unreachable message to the source location of the packet; or the action object is an object being associated with one of the alert-action object, the packet-drop-action object, the packet-admission-action object, the session-drop-action object, the session-admission-action object, the session-logging-action object, the traceback-action object and the ICMP-unreachable-message-sending-action object.

In accordance with still another preferred embodiment of the present invention, there is a method for editing a network security policy, comprising the steps of: editing a rule object; selecting and editing, as a condition object being associated with the rule object, one among an one-packet-condition, a repeated-packet-condition and a linear-packet-condition; and selecting and editing an action object being associated with the rule object, wherein the network security policy is represented by using the rule object including properties of a rule itself, the condition object for representing a condition which the rule is applied based on, the action object for representing an action to be performed when the condition is satisfied, an association between the rule object and the condition object and an association between the rule object and the action object, wherein the condition object is a one-packet-condition object for representing a condition for analyzing one packet, a repeated-packet-condition object for representing a case in which packets are repeatedly received, each of the packets having the same pattern, or a linear-packet-condition object for representing a case in which a series of packets having a predetermined pattern are successively received; or the condition object is an object being associated with one of the one-packet-condition object, the repeated-packet-condition object and the linear-packet-condition object, wherein the repeated-packet-condition object has one or more properties for representing an interval of time and the number of repeated packets; and the repeated-packet-condition object is associated with at least one one-packet-condition object for representing a condition for analyzing each of the repeated packets, and wherein the linear-packet-condition object has a property for representing the number of the series of packets; and the linear-packet-condition object is associated with at least one one-packet-condition object for representing a condition for analyzing each of the series of packets.

In accordance with still another preferred embodiment of the present invention, there is a method for editing a network security policy, comprising the steps of: editing a rule object; and selecting and editing, as an action object being associated with the rule object, one among an alert-action object, a packet-drop-action object, a packet-admission-action object, a session-drop-action object, a session-admission-action object, a session-logging-action object, a traceback-action object and an ICMP-unreachable-message-sending-action object, wherein the network security policy is represented by using the rule object including properties of a rule itself, the action object for representing a security action and an association between the rule object and the action object, wherein the action object is the alert-action object for representing an action of alerting a user to a rule application situation, the packet-drop-action object for representing an action of dropping a packet currently examined, the packet-admission-action object for representing an action of admitting the packet, the session-drop-action object for representing an action of dropping a session having the packet, the session-admission-action object for representing an action of admitting a session having the packet, the session-logging-action object for representing an action of storing information on a session having the packet, the traceback-action object for representing an action of tracing back to a source location of the packet or the ICMP-unreachable-message-sending-action object for representing an action of sending an ICMP-unreachable message to the source location of the packet; or the action object is an object being associated with one of the alert-action object, the packet-drop-action object, the packet-admission-action object, the session-drop-action object, the session-admission-action object, the session-logging-action object, the traceback-action object and the ICMP-unreachable-message-sending-action object.

### BRIEF DESCRIPTION OF THE DRAWINGS

The above and other objects and features of the present invention will become apparent from the following description of preferred embodiments, given in conjunction with the accompanying drawings, in which:

FIG. 1 is a block diagram showing a structure of a policy-based network security management system;

FIG. 2A is a block diagram showing a rule object with its associated condition objects in accordance with the present invention;

FIGS. 2B to 2D are block diagrams showing one-packet-condition objects with their associated objects in accordance with the present invention;

FIG. 2E is a block diagram showing a payload-matching-condition object with its associated objects in accordance with the present invention;

FIG. 2F is a block diagram showing a comparison-condition object with its associated objects in accordance with the present invention;

FIG. 3 is a block diagram showing a repeated-packet-condition object with its associated object in accordance with the present invention;

FIG. 4 is a block diagram showing a linear-packet-condition object with its associated objects in accordance with the present invention;

FIGS. 5A to 5I are block diagrams showing rule objects with their associated action objects in accordance with the present invention;

FIGS. 6A to 6E are block diagrams showing alert-action objects with their associated action objects in accordance with the present invention;

FIGS. 7 and 8 are examples of network security policies represented by objects and their associations in accordance with preferred embodiments of the present invention;

FIG. 9 is a flowchart describing a process of inserting a network security policy rule and its associated conditions and actions in accordance with a preferred embodiment of the present invention;

FIG. 10 is a flowchart describing a process of inserting an one-packet-condition and its associated conditions in accordance with the preferred embodiment of the present invention;

FIG. 11 is a flowchart describing a process of inserting a linear-packet-condition and its associated conditions in accordance with the preferred embodiment of the present invention;

FIG. 12 is a flowchart describing a process of inserting a repeated-packet-condition and its associated condition in accordance with the preferred embodiment of the present invention; and

FIG. 13 is a flowchart describing a process of inserting an alert-action and its associated actions in accordance with the preferred embodiment of the present invention.

### DETAILED DESCRIPTION OF THE PREFERRED EMBODIMENTS

Preferred embodiments of the present invention will be described in detail with reference to the accompanying drawings. It will be apparent that those who are skilled in the art are able to understand objects, features and advantages of the present invention through the preferred embodiments.

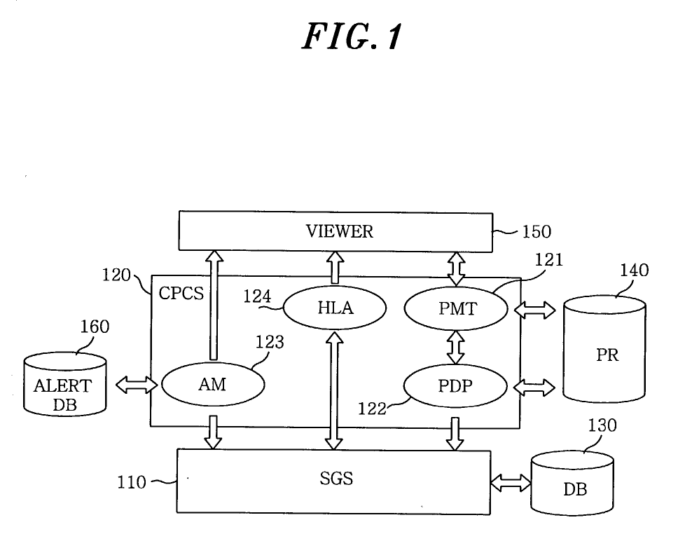

FIG. 1 is a block diagram showing a structure of a policy-based network security management system that employs a method for representing, storing and editing a network security policy in accordance with the present invention.

As described in FIG. 1, the security management system includes a cyber patrol control system (CPCS) 120 and at least one security gateway system (SGS) 110 connected thereto, wherein the CPCS 120 takes the role of a network security policy server and the SGS 110 plays the role of a client for the network security policy server.

The SGS 110 analyzes a packet transmitted from an external network to an internal network. If it is detected that a packet is transmitted for the purpose of intrusion into the internal network, the SGS 110 informs the CPCS 120 of the detection result. The CPCS 120 may use traffic information, log information and alert information transmitted from a plurality of SGSs 110 to detect a security situation that may not be detected by each of the SGSs 110. Then, the CPCS 120 may instruct the SGS 110 on a security policy which is needed for coping with the security situation.

Each of the SGSs 110 may include a sensor, an analyzer, a blocker and a cyber patrol agent. The CPCS 120 may include a policy management tool (PMT) 121, a policy decision point (PDP) 122, an alert manager (AM) 123 and a high level analyzer (HLA) 124.

The sensor of each of the SGSs 110 copies packets transmitted from the external network into the internal network and extracts only necessary information from the copied packets. The analyzer analyzes the information extracted from the sensor in comparing with the security policy that is transmitted from the CPCS 120 and stored in a database (DB) 130. And then, the analyzer determines whether the packet is transmitted on purpose to intrude into the internal network or not. The cyber patrol agent gathers the intrusion information detected by the analyzer and transmits the intrusion information to the CPCS 120. Further, the cyber patrol agent receiving policy from the CPCS 120 may instruct a blocker to drop the packet or a session having the packet.

A user of the CPCS 120 generates a network security policy by using the PMT 121 and stores the network security policy in a policy repository (PR) 140. If necessary, the user may edit the network security policy stored in the PR 140 by using the PMT 121. Whenever performing the operations of storing and editing, the PMT 121 informs the PDP 122 of the operation results. The PDP 122 selects the network security policy to be performed and transmits the determined network security policy from the PR 140 to its corresponding SGS 110. The AM 123 stores alert data received from a plurality of SGSs 110 in an alert database 160. In addition, the AM 123 analyzes the stored alert data and informs the user of the analysis result through a viewer 150. The HLA 124 of the CPCS 120 detects a security situation, which may not be detected by each of the SGSs 110, by using the traffic information and the log information received from the SGS 110.

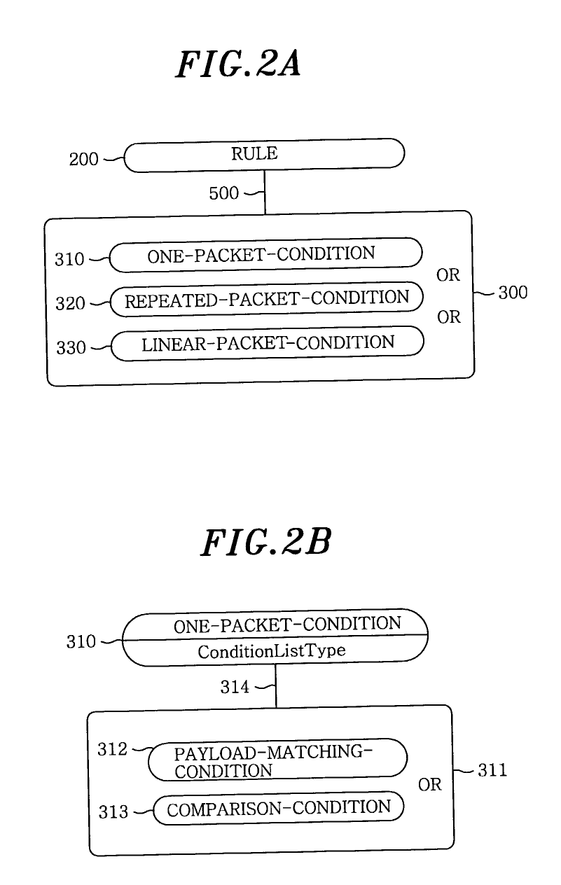

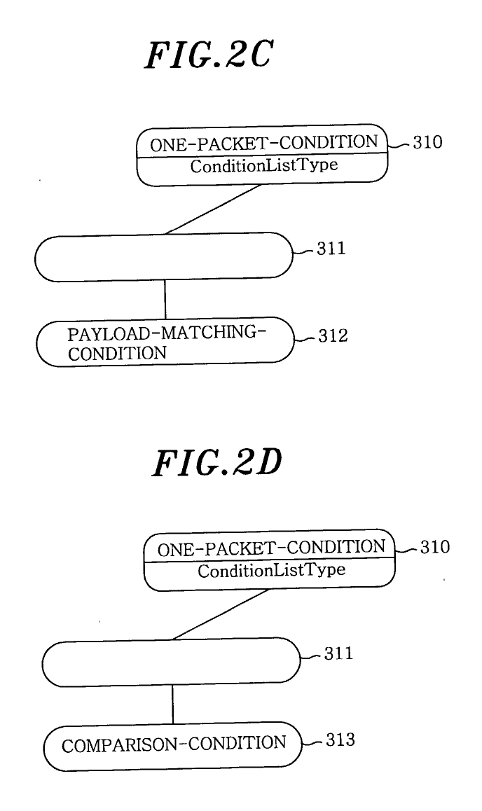

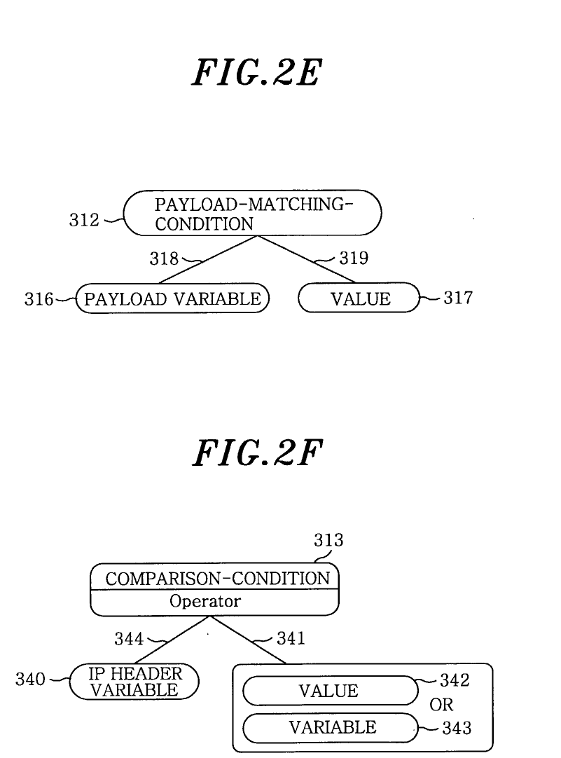

Objects and associations comprising the network security policy now will be described in detail with reference to FIGS. 2A to 6E, wherein the user of the CPCS 120 represents and stores the network security policy by using the PMT 121 as described above.

As described in FIG. 2A, a condition object 300 having an association 500 with a rule object 200 may be a one-packet-condition object 310, a repeated-packet-condition object 320, or a linear-packet-condition object 330.

The one-packet-condition object 310 represents a condition for one packet. The repeated-packet-condition object 320 represents a condition for a case in which a number of packets are repeatedly received, each of the packets having the same pattern. The linear-packet-condition object 330 represents a condition for a case in which a series of packets having a predetermined pattern are successively received.

FIG. 2B illustrates the one-packet-condition object 310 with its associated objects. The one-packet-condition object 310 has a property ConditionListType representing a method for combining (e.g., AND/ORing) items to be analyzed. The one-packet-condition object 310 has an association 314 with additional condition objects 311 each of which specifies each of the items to be analyzed. The condition object 311 may be a payload-matching-condition object 312 for examining a payload of a packet or a comparison-condition object 313 for examining a field of a packet header. Further, as shown in FIGS. 2C and 2D, the condition object 311 may be associated with the payload-matching-condition object 312 or the comparison-condition object 313.

As illustrated in FIG. 2E, the payload-matching-condition object 312 has not only an association 318 with a payload variable object 316 representing a payload but also an association 319 with a value object 317 representing a value to be compared with the payload.

Further, as illustrated in FIG. 2F, the comparison-condition object 313 has a property Operator representing an operator to be used in examining a field of a packet header. The comparison-condition object 313 has an association 344 with an IP header variable object 340 representing a field to be examined, and has an association 341 with a value object 342 representing a value to be compared with the field or a variable object 343 representing another variable to be compared.

FIG. 3 depicts a repeated-packet-condition object 320 with its associated object. As described in FIG. 3, the repeated-packet-condition object 320 has a property IntervalOfTime for representing an interval of time and a property BoundOfNumberOfPackets for representing the number of the repeated packets. Also, the repeated-packet-condition object 320 has an association 321 with another condition object, i.e., an one-packet-condition object 310. The one-packet-condition object 310 represents each of the repeated packets.

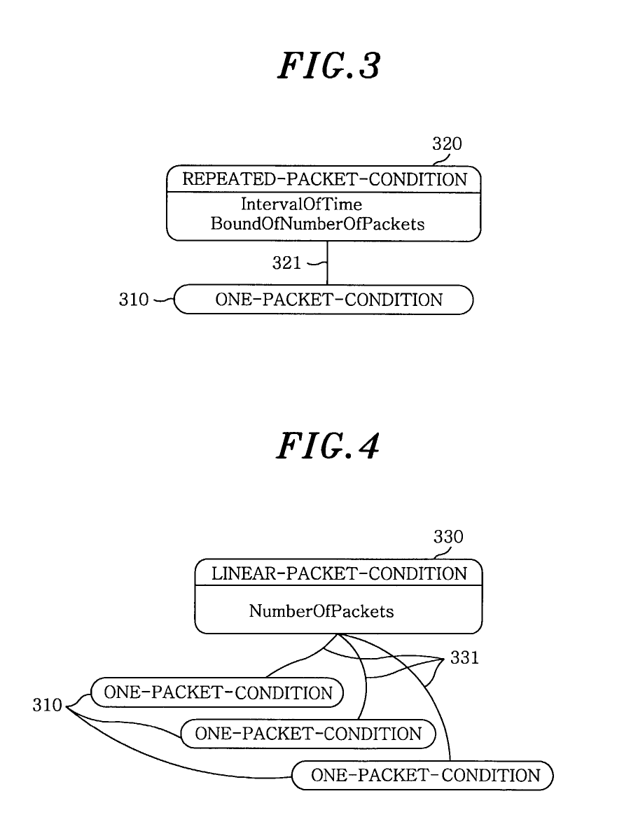

FIG. 4 represents a linear-packet-condition object 330 with its associated objects. The linear-packet-condition object 330 has a property NumberOfPackets for representing the number of packets to be analyzed. Also, the linear-packet-condition object 330 has associations 331 with a plurality of one-packet-condition objects 310 each of which represents each of the packets.

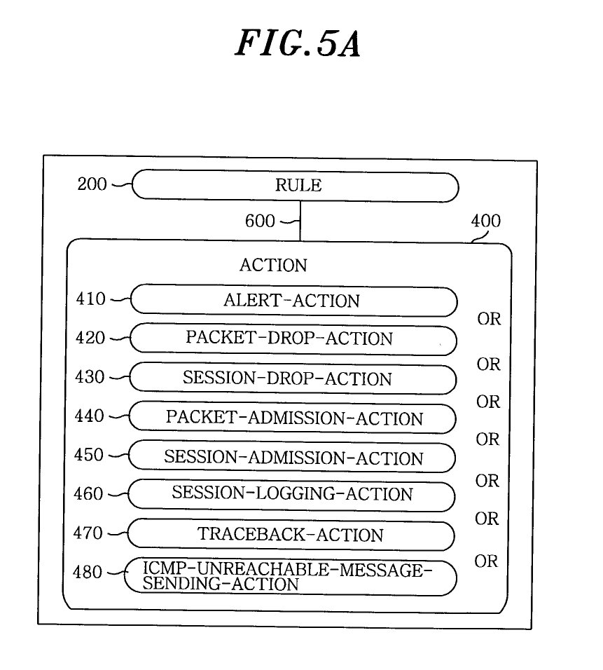

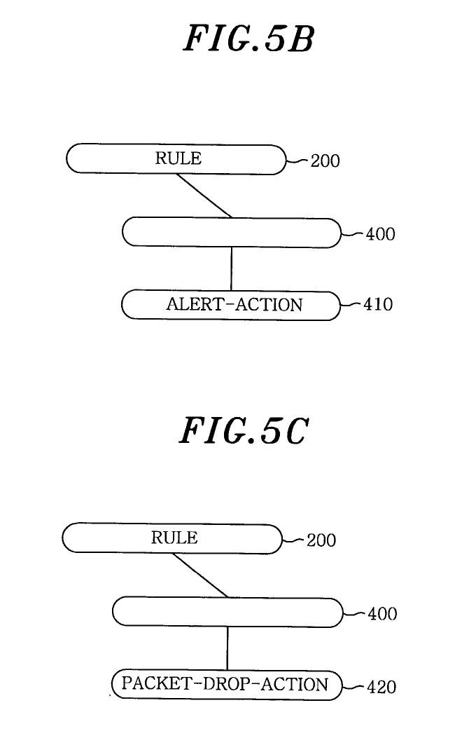

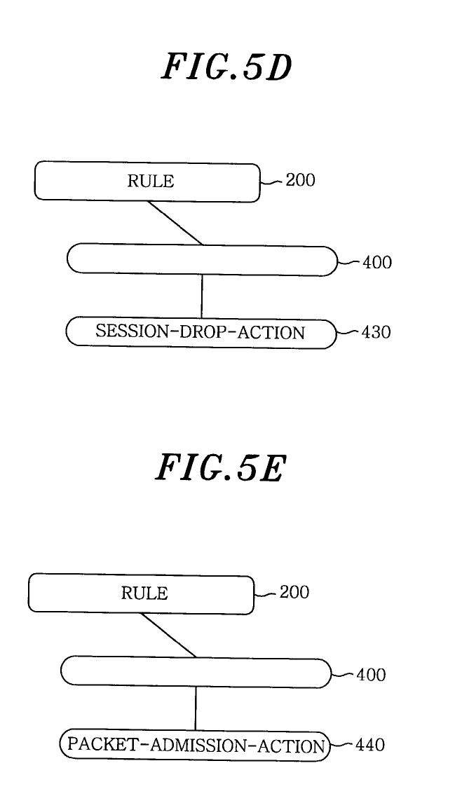

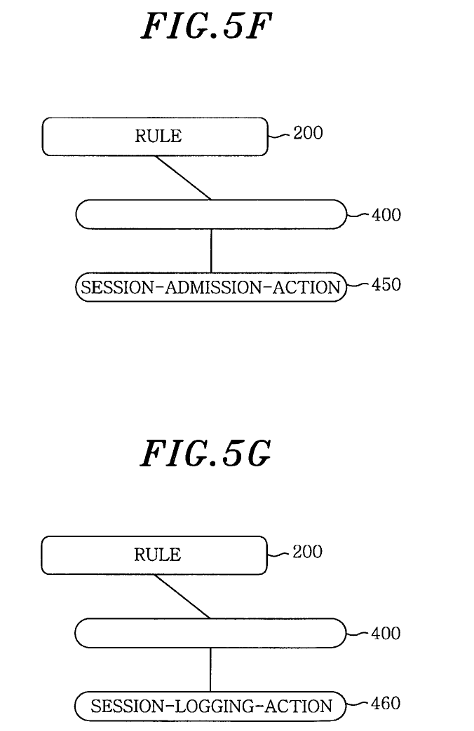

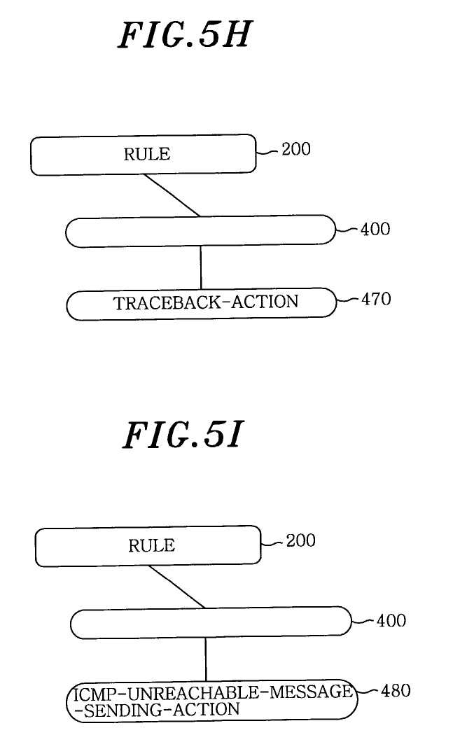

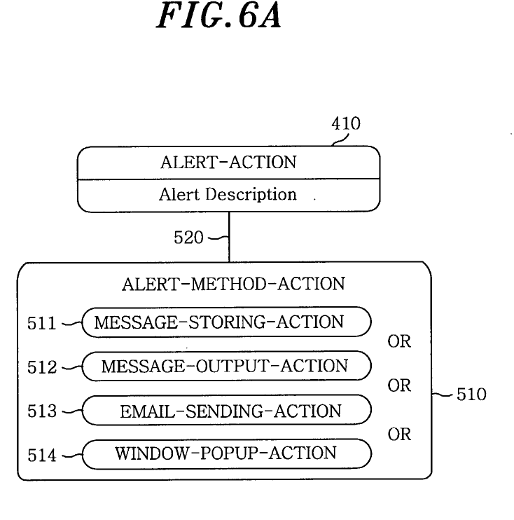

In the meanwhile, FIG. 5A presents an action object 400 for representing a security action to be performed for an external intrusion. As described in FIG. 5A, the action object 400, which has an association 600 with a rule object 200, may be an alert-action object 410, a packet-drop-action 420, a session-drop-action object 430, a packet-admission-action object 440, a session-admission-action object 450, a session-logging-action object 460, a traceback-action object 470 or an ICMP-unreachable-message-sending-action object 480. The alert-action object 410 represents an action of reporting a rule application result. The packet-drop-action 420 represents an action of dropping a packet. The session-drop-action object 430 represents an action of dropping a session having the packet. The packet-admission-action object 440 represents an action of admitting the packet. The session-admission-action object 450 represents an action of admitting a session having the packet. The session-logging-action object 460 represents an action of storing information on the session in which the packet is included. The traceback-action object 470 represents an action of tracing back to a source location of the packet. The ICMP-unreachable-message-sending-action object 480 represents an action of sending an ICMP-unreachable message to a source of the packet.

As described in FIGS. 5B to 5I, the action object 400 may be associated with one of the alert-action object 410, the packet-drop-action object 420, the session-drop-action object 430, the packet-admission-action object 440, the session-admission-action object 450, the session-logging-action object 460, the traceback-action object 470 and the ICMP-unreachable-message-sending-action object 480.

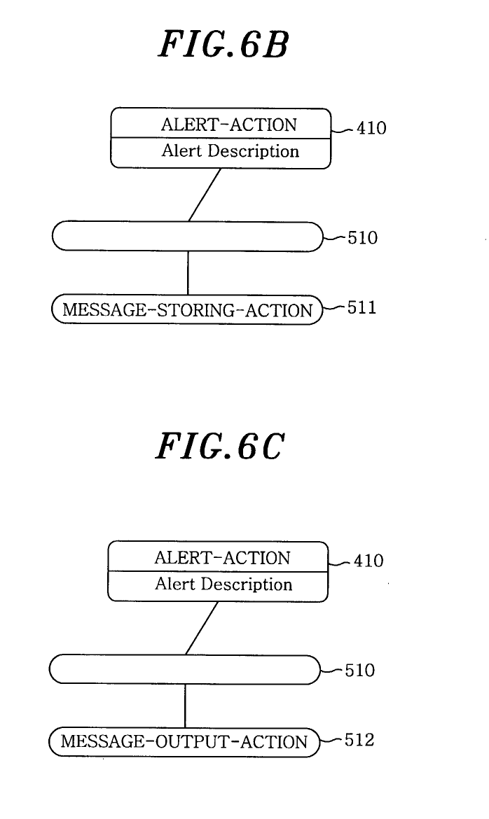

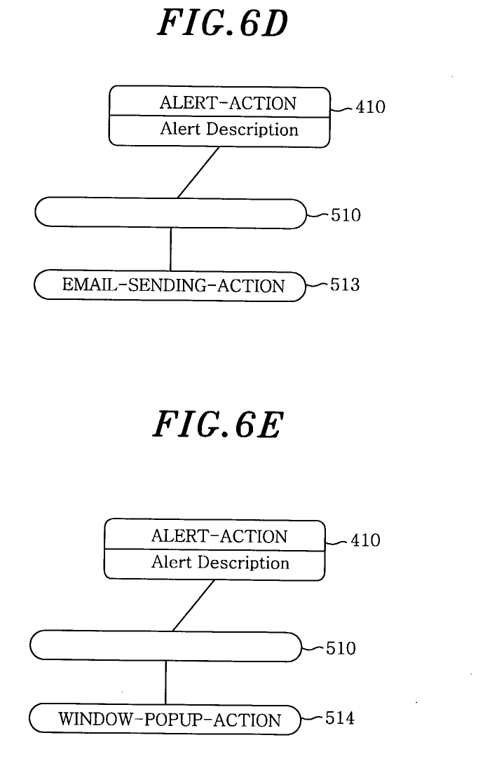

As described in FIG. 6A, the alert-action object 410 has a property AlertDescription for representing a description on the rule application situation. Also, the alert-action object 410 has an association 520 with at least one alert-method-action object 510 representing a method for alerting a user to the situation.

The alert-method-action object 510 may be a message-storing-action object 511 for representing an action of storing an alert message, a message-output-action object 512 for representing an action of outputting the alert message, an email-sending-action object 513 for representing an action of sending the alert message by e-mail or a window-popup-action object 514 for representing an action of opening a new window for showing the alert message. As shown in FIGS. 6B to 6E, the alert-method-action object 510 may be associated with one of the message-storing-action object 511, the message-output-action object 512, the email-sending-action object 513 and the window-popup-action object 514.

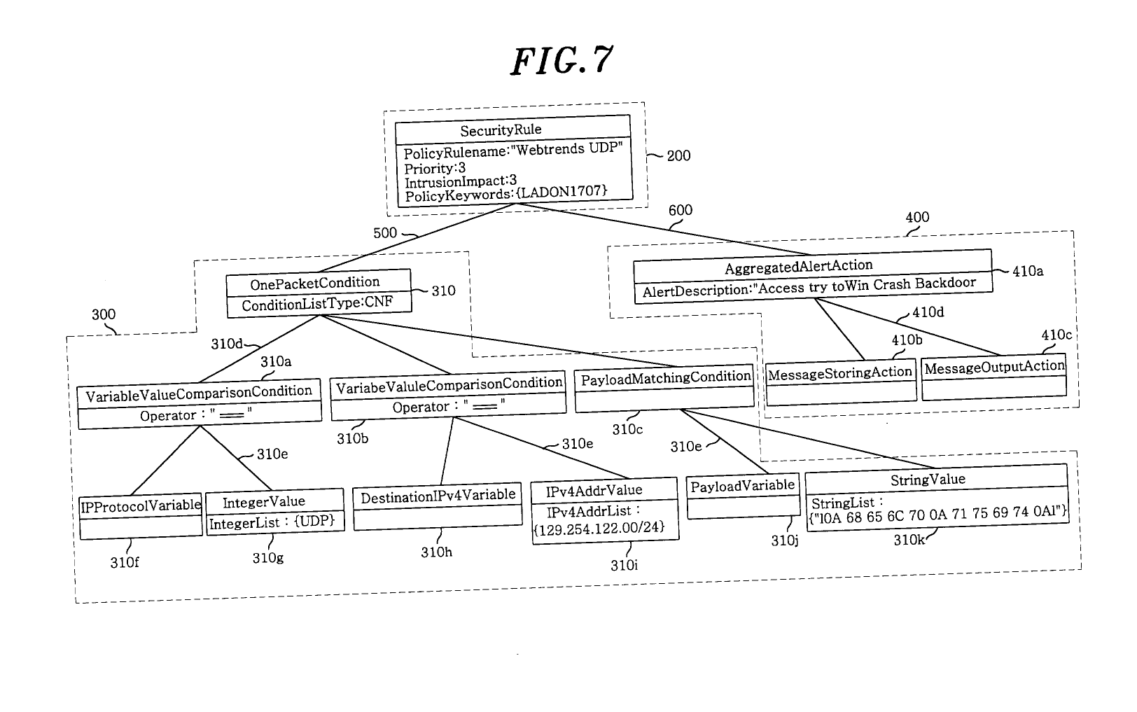

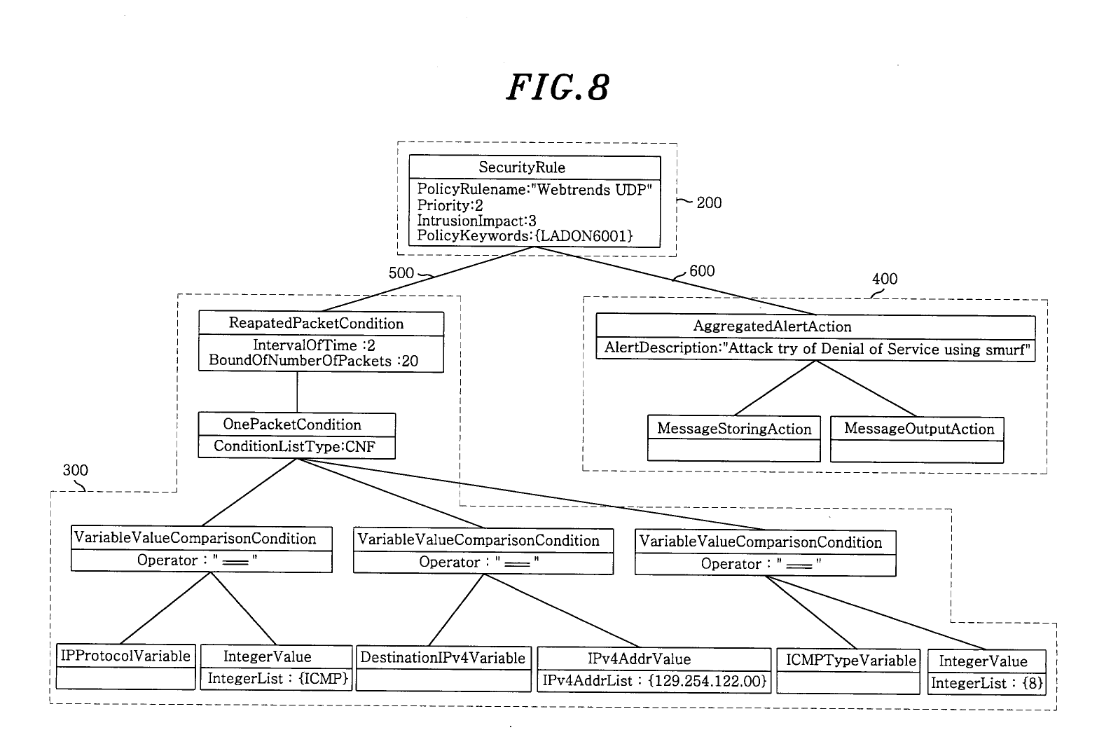

FIGS. 7 and 8 illustrate examples of network security policies represented by the rule objects, the condition objects, the action objects and their associations described above.

FIG. 7 depicts the following policy rule: a message of “Access try to WinCrash Backdoor” is stored and outputted if a destination of a user datagram protocol (UDP) packet transmitted from an external communication network is “129.254.122.00/24” and a payload of the packet has a hexadecimal “0A 68 65 6c 70 0A 71 75 69 74 0A”. The action for storing the message is to store it in the alert DB 160 in the security management system. The action for outputting the message is to display it through the viewer 150 so that a user can recognize it.

In the security rule described in FIG. 7, SecurityRule is a class for the rule object 200 including properties of the rule itself. OnePackeCondition is a class for the one-packet-condition object 310 representing a condition for one packet. ConditionListType is a property for a combining method of items to be analyzed. VariableValueComparisonCondition is a class for each of the comparison-condition objects 310a and 310b for representing conditions for comparing a certain field of a packet header with a value. Operator is a property for an operator (i.e., “==”) to be used during the comparing process. PayloadMatchingCondition is a class for the payload-matching-condition object 310c for representing a condition for analyzing contents in a payload of a packet. PayloadVariable is a class for a variable object 310j for representing the payload. Further, AggregatedAlertAction is a class for an alert-action object 410a for representing an alert-action on the rule application situation, wherein AggregatedAlertAction has a property of AlertDescription for representing a description on the rule application situation. MessageStoringAction is a class for a message-storing-action object 410b for representing an action of storing an alert message, and MessageOutputAction is a class for a message-output-action object 410c for representing an action of outputting the alert message.

FIG. 8 depicts another exemplary policy rule including a repeated-packet-condition for representing a condition for analyzing repeated packets. The policy rule is as follows: a message of “Attack try of Denial of Service using smurf” is stored and outputted if at least 20 ICMP packets, each of which has a destination of “129.254.122.00” and an ICMP type of “8”, are received for 2 seconds.

The security policy illustrated in FIG. 8 uses the classes and properties that are illustrated in FIG. 7. However, in FIG. 8, RepeatedPacketConditon is used as a class for a repeated-packet-condition object. RepeatedPacketCondition has a property of IntervalOfTime for representing an interval of time and BoundOfNumberOfPackets for representing the number of repeated packets. Further, a RepeatedPacketCondition object is associated with a OnePacketCondition object.

The network security policies, which are represented by the rule objects, the condition objects, the action objects and their associations as described with reference to FIGS. 2A to 8, may be edited by a user in accordance with changes in a network security situation. The editing process of the network security policy includes an insertion process, a deletion process or a modification process of the rule objects, the condition objects, the action objects and their associations.

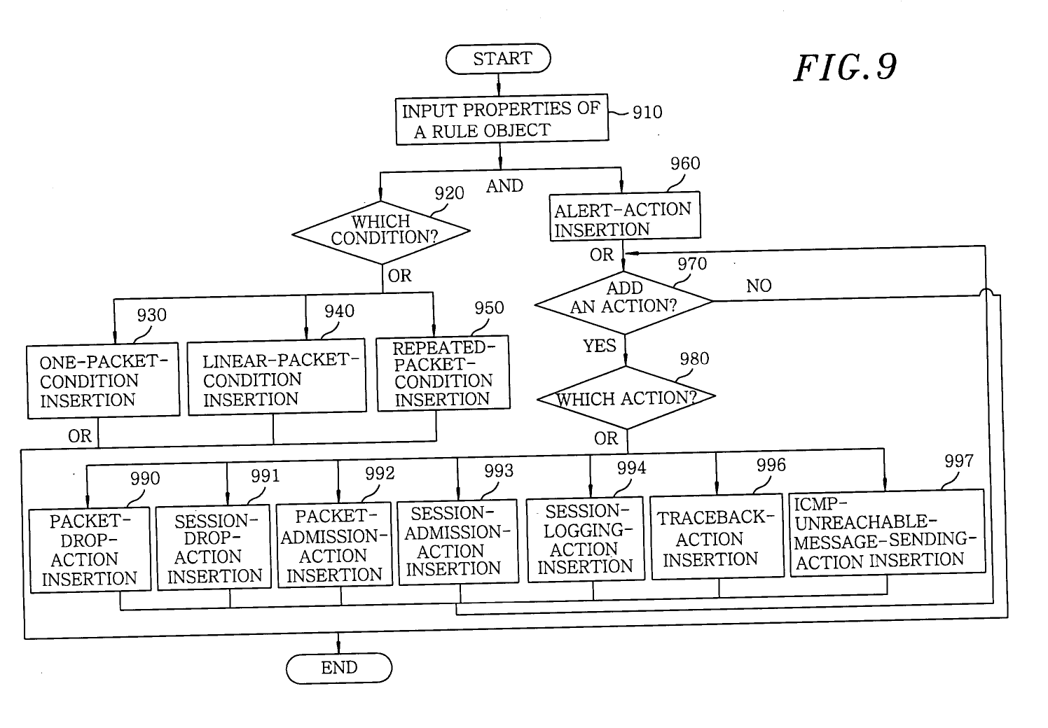

FIG. 9 is a flowchart showing a process of inserting a policy rule in accordance with a preferred embodiment of the present invention. As illustrated in FIG. 9, first, a user inputs one or more properties of the rule object (step 910). The properties of the rule object may be PolicyRulename, Priority, IntrusionImpact and so on.

After the user inputs the properties of the rule object, the user selects one among a one-packet-condition, a linear-packet-condition and a repeated-packet-condition (step 920).

The process of inserting one among the one-packet-condition, the linear-packet-condition and the repeated-packet-condition is performed by inputting one or more properties of the condition and inserting other conditions being associated with the selected condition (steps 930 to 950).

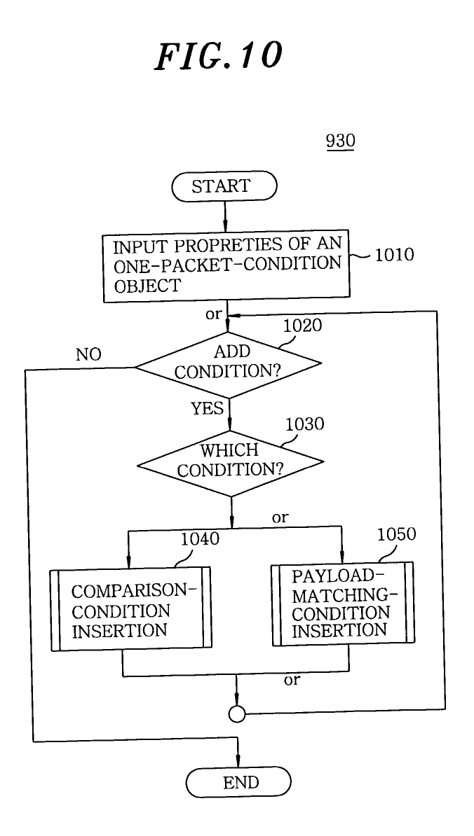

When the user selects and inserts the one-packet-condition, an operation of inserting the condition (step 930) may be performed as illustrated in FIG. 10.

First, the user inputs one or more properties of the one-packet-condition object (step 1010). As illustrated in FIG. 2B, the one-packet-condition object 310 has a property ConditionListType and/or other properties. Next, the user decides whether to add another condition being associated with the one-packet-condition or not (step 1020). When the user has determined to add another condition (or condition object), a type of the condition to be added is determined (step 1030). The addible condition, which will be associated with the one-packet-condition, as illustrated in FIGS. 2B, may be a payload-matching-condition 312 or a comparison-condition 313. The process of inserting either one of the comparison-condition and the payload-matching-condition (step 1040 or 1050) is implemented by inputting the properties of the comparison-condition object or the payload-matching-condition object and then inserting other objects being associated with the condition object. As illustrated in FIG. 2E, the other objects associated with the payload-matching-condition object 312 are a payload variable object 316 and a value object 317. As illustrated in FIG. 2F, the other objects associated with the comparison-condition object 313 are an IP header variable object 340 and another variable object 343 (or value object 342). After the user finishes the insertion process of the condition being associated with the one-packet-condition (step 1040 or 1050), it is determined whether to add another condition or not (step 1020). If the user does not want to add another condition, the insertion process of the one-packet-condition (step 930) is terminated.

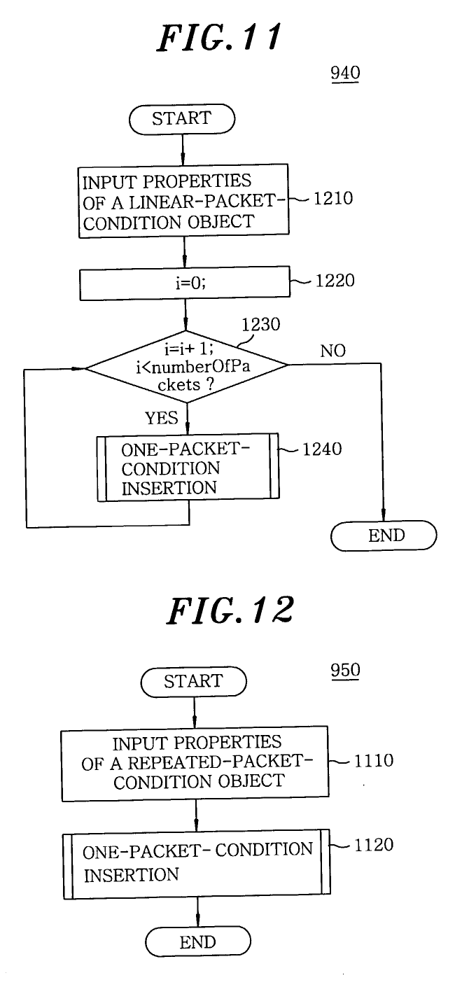

FIG. 11 illustrates an operation of inserting the linear-packet-condition into a network security policy (step 940).

First, the user inputs one or more properties of the linear-packet-condition object (step 1210). As illustrated in FIG. 4, the properties of the linear-packet-condition 330 may be NumberOfPackets and/or other properties. Next, the user inserts one-packet-conditions being associated with the linear-packet-condition (steps 1220 to 1240). The insertion process thereof is described above with reference to FIG. 10.

If the user selects and inserts the repeated-packet-condition, an operation of inserting the repeated-packet-condition (step 950) is performed as illustrated in FIG. 12.

First, the user inputs one or more properties of the repeated-packet-condition (step 1110). As illustrated in FIG. 3, the properties of the repeated-packet-condition object 320 may be IntervalOfTime, BoundOfNumberOfPackets or other properties. Next, the user inserts a one-packet-condition being associated with the repeated-packet-condition (step 1120). The insertion process thereof is described above with reference to FIG. 10.

Next, the user inserts an action to be performed when the condition (represented by the objects inserted in the steps 930 to 950) is satisfied.

As illustrated in FIG. 9, the insertion process of the condition or that of the action can be performed in advance to each other. Alternatively, both the processes can be performed in parallel. Further, only the insertion process of the action can be performed without the insertion process of condition.

The insertion process of an action object with its associated objects is performed as follows.

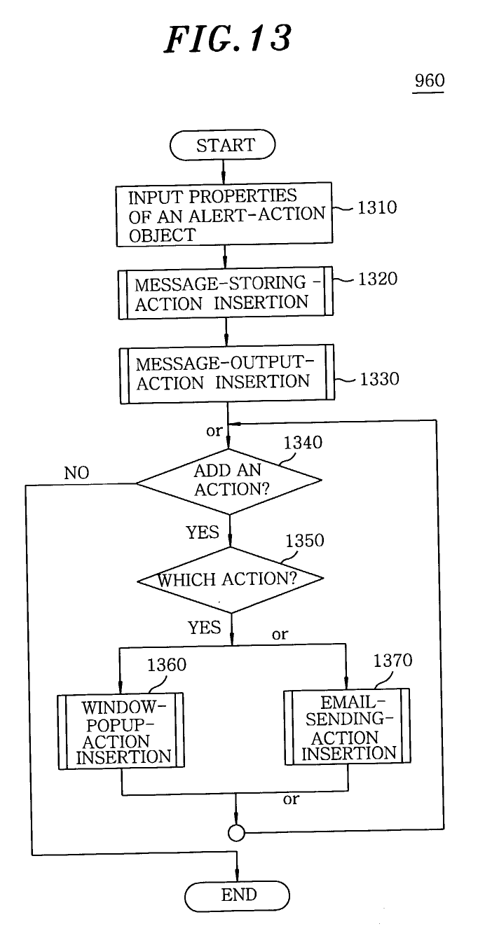

First, the user inserts an alert-action (step 960). The insertion process thereof is illustrated in FIG. 13.

The user inputs one or more properties of the alert-action object (step 1310). As illustrated in FIG. 6A, the alert-action object 410 has a property of AlertDescription for representing a description on the rule application situation. Next, the user inserts a message-storing-action 511 and a message-output-action 512, each of which has an association with the alert-action 410 (steps 1320 and 1330). After inserting the message-storing-action 511 and the message-output-action 512, the user decides whether to add another action (step 1340). If the user has decided to add another action, the user determines which action to be added (step 1350). Then, the determined action, i.e., either the window-popup-action 514 or the email-sending-action 513, is inserted (step 1360 or 1370). If the user has decided not to add another action any more, the insertion process of the alert-action is terminated.

After the user inserts the alert-action (step 960), it is determined whether to add another action or not (step 970). As illustrated in FIG. 9, another action object can be added by selecting and inserting one among the packet-drop-action 420, the session-drop-action 430, the packet-admission-action 440, the session-admission-action 450, the session-logging-action 460, the traceback-action 470 and the ICMP-unreachable-message-sending-action 480 (steps 980 and 990 to 997).

The network security policy, which is represented by the rule objects, the condition objects, the action objects and their associations as described above, is stored in the PR 140. The stored network security policy can be entirely or partially edited by a user, if necessary. The editing process thereof can be performed through a deletion/insertion of some of the objects or a modification of properties of the objects.

As described above, the present invention provides a method for representing, storing and editing a network security policy with extensiblity and flexibility in a policy-based network security management system, so that time and cost for developing the policy-based network security management system can be reduced.

Especially, in accordance with the present invention, a designer of the network security management system can directly design an operational structure of the PMT 121, a database schema of the PR 140 and policy object classes transferred from the CPCS 120 to the SGS 110.

Further, according to the present invention, policy rules can be flexibly changed by slightly modifying or even without modifying the operational structure of the PMT 121, the database schema of the PR 140 and the policy object classes transferred from the CPCS 120 to the SGS 110.

While the invention has been shown and described with respect to the preferred embodiments, it will be understood by those skilled in the art that various changes and modifications may be made without departing from the spirit and scope of the invention as defined in the following claims.

What is claimed is:

1. A method for storing a network security policy, comprising a step of:
storing the network security policy by using a rule object including properties of a rule itself, a condition object for representing a condition which the rule is applied based on, an action object for representing an action to be performed when the condition is satisfied, an association between the rule object and the condition object and an association between the rule object and the action object,
wherein the condition object is a one-packet-condition object for representing a condition for analyzing one packet, a repeated-packet-condition object for representing a case in which packets are repeatedly received, each of the packets having the same pattern, or a linear-packet-condition object for representing a case in which a series of packets having a predetermined pattern are successively received; or the condition object is an object being associated with one of the one-packet-condition object, the repeated-packet-condition object and the linear-packet-condition object,
wherein the repeated-packet-condition object has one or more properties for representing an interval of time and the number of repeated packets; and the repeated-packet-condition object is associated with at least one one-packet-condition object for representing a condition for analyzing each of the repeated packets, and
wherein the linear-packet-condition object has a property for representing the number of the series of packets; and the linear-packet-condition object is associated with at least one one-packet-condition object for representing a condition for analyzing each of the series of packets.

2. The method of claim 1, wherein the one-packet-condition object has a property for representing a method for combining items to be analyzed; and the one-packet-condition object is associated with at least one condition object for specifying each of the items to be analyzed.

3. The method of claim 2, wherein the condition object for specifying each of the items to be analyzed is a payload-matching-condition object for examining a payload of a packet,
wherein the payload-matching-condition object is associated with a variable object for representing the payload and a value object for representing a value to be compared with the payload.

4. The method of claim 2, wherein the condition object for specifying each of the items to be analyzed is a comparison-condition object for representing a condition for examining a field of a header of the packet,
wherein the comparison-condition object has a property for representing an operator to be used in examining the field; and the comparison-condition object is associated with a variable object for representing the field and a value object for representing a value to be compared with the field.

5. The method of claim 2, wherein the condition object specifying each of the items to be analyzed is a comparison-condition object for representing a condition for examining a field of a header of the packet,
wherein the comparison-condition object has a property for representing an operator to be used in examining the field; and the comparison-condition object is associated with a variable object for representing the field and another variable object for representing another variable to be compared with the field.

6. A method for storing a network security policy, comprising a step of:
storing the network security policy by using a rule object including properties of a rule itself, an action object for representing a security action and an association between the rule object and the action object,
wherein the action object is an alert-action object for representing an action of alerting a user to a rule application situation, a packet-drop-action object for representing an action of blocking a packet currently examined, a packet-admission-action object for representing an action of admitting the packet, a session-drop-action object for representing an action of blocking a session having the packet, a session-admission-action object for representing an action of admitting a session having the packet, a session-logging-action object for representing an action of storing information on a session having the packet, a traceback-action object for representing an action of tracing back to a source location of the packet, or an ICMP-unreachable-message-sending-action object for representing an action of sending an ICMP-unreachable message to the source location of the packet; or the action object is an object being associated with one of the alert-action object, the packet-drop-action object, the packet-admission-action object, the session-drop-action object, the session-admission-action object, the session-logging-action object, the traceback-action object and the ICMP-unreachable-message-sending-action object.

7. The method of claim 6, wherein the alert-action object has a property for representing the rule application situation; and the alert-action object is associated with at least one alert-method-action object for representing an alert method.

8. The method of claim 7, wherein the alert-method-action object is a message-storing-action object for representing an action of storing an alert message, a message-output-action object for representing an action of displaying the alert message, a email-sending-action object for representing an action of sending the alert message by email or a window-popup-action object for representing an action of opening a new window for showing the alert message; or the alert-method-action is an object being associated with one of the message-storing-action object, the message-output-action object, the email-sending-action object and the window-popup-action object.

9. A method for editing a network security policy, comprising the steps of:
editing a rule object;
selecting and editing, as a condition object being associated with the rule object, one among an one-packet-condition, a repeated-packet-condition and a linear-packet-condition; and
selecting and editing an action object being associated with the rule object,
wherein the network security policy is represented by using the rule object including properties of a rule itself, the condition object for representing a condition which the rule is applied based on, the action object for representing an action to be performed when the condition is satisfied, an association between the rule object and the condition object and an association between the rule object and the action object,
wherein the condition object is a one-packet-condition object for representing a condition for analyzing one packet, a repeated-packet-condition object for representing a case in which packets are repeatedly received, each of the packets having the same pattern, or a linear-packet-condition object for representing a case in which a series of packets having a predetermined pattern are successively received; or the condition object is an object being associated with one of the one-packet-condition object, the repeated-packet-condition object and the linear-packet-condition object,
wherein the repeated-packet-condition object has one or more properties for representing an interval of time and the number of repeated packets; and the repeated-packet-condition object is associated with at least one one-packet-condition object for representing a condition for analyzing each of the repeated packets, and
wherein the linear-packet-condition object has a property for representing the number of the series of packets; and the linear-packet-condition object is associated with at least one one-packet-condition object for representing a condition for analyzing each of the series of packets.

10. The method of claim 9, wherein the step of selecting and editing the one-packet-condition object includes the stages of:
inputting a property for representing a method for combining items to be analyzed; and
inserting at least one of a payload-matching-condition object and a comparison-condition object, wherein the payload-matching condition object represents a condition for examining a payload of a packet and the comparison-condition object represents a condition for examining a field of a header of the packet.

11. The method of claim 9, wherein the step of selecting and editing the repeated-packet-condition object includes the stages of:
inputting a property for representing an interval of time and a property for representing the number of the repeated packets; and
inserting an one-packet-condition object for representing each of the repeated packets.

12. The method of claim 9, wherein the step of selecting and editing the linear-packet-condition object includes the stages of:
inputting a property for representing the number of packets to be analyzed; and
inserting a plurality of one-packet-condition objects each of which represents each of the series of the packets.

13. The method of claim 9, wherein the one-packet-condition object has a property for a method for combining items to be analyzed; and the one-packet-condition object is associated with at least one condition object for specifying each of the items to be analyzed.

14. The method of claim 13, wherein the condition object for specifying each of the items to be analyzed is a payload-matching-condition object for representing a condition for examining a payload of a packet
wherein the payload-matching-condition object is associated with a variable object for representing the payload and a value object for representing a value to be compared with the payload.

15. The method of claim 13, wherein the condition object for specifying each of the items to be analyzed is a comparison-condition object for representing a condition for examining a field of a header of the packet,
wherein the comparison-condition object has a property for representing an operator to be used in examining the field; and the comparison-condition object is associated with a variable object for representing the field and a value object for representing a value to be compared with the field.

16. The method of claim 13, wherein the condition object for specifying each of the items to be analyzed is a comparison-condition object for representing a condition for examining a field of a header of the packet,
wherein the comparison-condition object has a property for representing an operator to be used in examining the field; and the comparison-condition object is associated with a variable object for representing the field and another variable object for representing another variable to be compared with the field.

17. A method for editing a network security policy, comprising the steps of:
editing a rule object; and
selecting and editing, as an action object being associated with the rule object, one among an alert-action object, a packet-drop-action object, a packet-admission-action object, a session-drop-action object, a session-admission-action object, a session-logging-action object, a traceback-action object and an ICMP-unreachable-message-sending-action object,
wherein the network security policy is represented by using the rule object including properties of a rule itself, the action object for representing a security action and an association between the rule object and the action object,
wherein the action object is the alert-action object for representing an action of alerting a user to a rule application situation, the packet-drop-action object for representing an action of dropping a packet currently examined, the packet-admission-action object for representing an action of admitting the packet, the session-drop-action object for representing an action of dropping a session having the packet, the session-admission-action object for representing an action of admitting a session having the packet, the session-logging-action object for representing an action of storing information on a session having the packet, the traceback-action object for representing an action of tracing back to a source location of the packet or the ICMP-unreachable-message-sending-action object for representing an action of sending an ICMP-unreachable message to the source location of the packet; or the action object is an object being associated with one of the alert-action object, the packet-drop-action object, the packet-admission-action object, the session-drop-action object, the session-admission-action object, the session-logging-action object, the traceback-action object and the ICMP-unreachable-message-sending-action object.

18. The method of claim 17, wherein the alert-action object has a property for representing the rule application situation; and the alert-action object is associated with at least one alert-method-action object for representing an alert method.

19. The method of claim 18, wherein the alert-method-action object is a message-storing-action object for representing an action of storing an alert message, a message-output-action object for representing an action of displaying the alert message, a email-sending-action object for representing an action of sending the alert message by e-mail or a window-popup-action object for representing an action of opening a new window for showing the alert message; or the alert-method-action object is an object being associated with one of the message-storing-action object, the message-output-action object, the email-sending-action object and the window-popup-action object.
